(19) United States
(12) Patent Application Publication
(10) Pub. No.: US 2001/0052716 A1
(43) Pub. Date: Dec. 20, 2001

(54) Dashboard, corresponding dashboard module and its manufacturing process

(76) Inventors: Christophe Lyonnet, Montbeliard (FR); Pascal Query, Ronchamp (FR); Guy Vuillemin, Baume-Les-Dames (FR)

Correspondence Address: SUGHRUE, MION, ZINN, MACPEAK & SEAS, 2100 Pennsylvania Avenue, N.W., Washington, DC, 20037-3213, US

(21) Appl. No.: 09/855,696

(22) Filed: May 16, 2001

(30) Foreign Application Priority Data
May 18, 2000 (FR) 0006393

(51) Int. Cl. B62D 25/14

(52) U.S. Cl. 296/72

(57) ABSTRACT

This dashboard for a motor vehicle comprises a core (4) made of plastic foam, which includes recesses forming air ducts (12), and a covering (20) comprising a fiber mat (22) incorporated into a layer of polymer resin (24). The covering is a stiffening covering (20) completely surrounding the perimeter of the cross section of the core (4) over at least one portion of the length of the latter.

The present invention relates to a dashboard for a motor vehicle, of the type comprising a core made of plastic foam, consisting of several partial cores, including recesses forming air ducts or locations for components, and having a covering comprising a fibre mat incorporated into a layer of polymer resin.

It furthermore relates to a process for manufacturing such a dashboard.

In the prior art, motor-vehicle dashboards are known which consist of a core of polypropylene foam produced from various partial cores joined together. The partial cores are joined together, for example, by adhesive bonding. The core may be covered with a decorative skin. Such a dashboard is proposed, for example, in document DE-A-44 23 108. This dashboard has the drawback of having a low stiffness.

Also known, from document GB-A-2 335 396, is a dashboard comprising a transverse metal bar which is surrounded by a body of plastic foam. The transverse bar serves as a support for the body. The body is covered only over its visible surface by a glass mat shell dip-coated with thermoplastic. The dashboard known from this document is heavy because of the transverse bar and the stiffness of the dashboard essentially depends on this bar.

It is an object of the present invention to overcome these drawbacks and to provide a dashboard which is stiff and has a low manufacturing cost.

For this purpose, the subject of the invention is a dashboard for a motor vehicle of the aforementioned type, characterized in that the covering is a stiffening covering completely surrounding the perimeter of the cross section of the core over at least part of the length of the latter.

The subject of the invention is also a dashboard module comprising a dashboard as defined above and at least one item of equipment fastened to it.

The module according to the invention may include an airbag module fitted into the recess, this airbag module having an integrated cover. It may furthermore include an airbag module and an attached cover which covers the rear opening of the recess and which is fastened to the perimeter of this recess.

The subject of the invention is also a process for manufacturing a dashboard as defined above, characterized in that:

partial cores of plastic foam are assembled into a core;

the core is covered with a fibre mat so that the perimeter of the cross section of the core is completely surrounded by the fibre mat;

the covered core is placed in a mould;

polymer resin is injected into the mould so that the fibre mat is completely incorporated into a layer of polymer resin;

the polymer resin is left to cure and the dashboard is demoulded; and

openings for air ducts and/or locations for components are cut out.

As a variant, the process may comprise the following steps:

partial cores of plastic foam are assembled into a core;

preformed pieces of fibre mat of a shape substantially complementary to that of the core are placed in the die and/or the punch of a mould, the preformed pieces having a total surface area completely covering the core;

the core is placed in the mould;

polymer resin is injected into the mould so that the fibre mat is completely incorporated into a layer of polymer resin;

the polymer resin is left to cure and the dashboard is demoulded; and

openings for air ducts and/or locations for components are cut out.

According to particular methods of implementation, the process may furthermore include the following steps:

before the polymer resin is injected, of placing fastening elements on temporary retention elements arranged in the mould;

of placing fibre mat pieces on the temporary retention elements arranged in the mould before the fastening elements are put into place;

of placing a decorative skin in the mould and of injecting polymer resin onto the face of the decorative skin being applied against the dashboard.

The invention will be more clearly understood on reading the description which follows, given solely by way of example and with reference to the appended drawings in which:

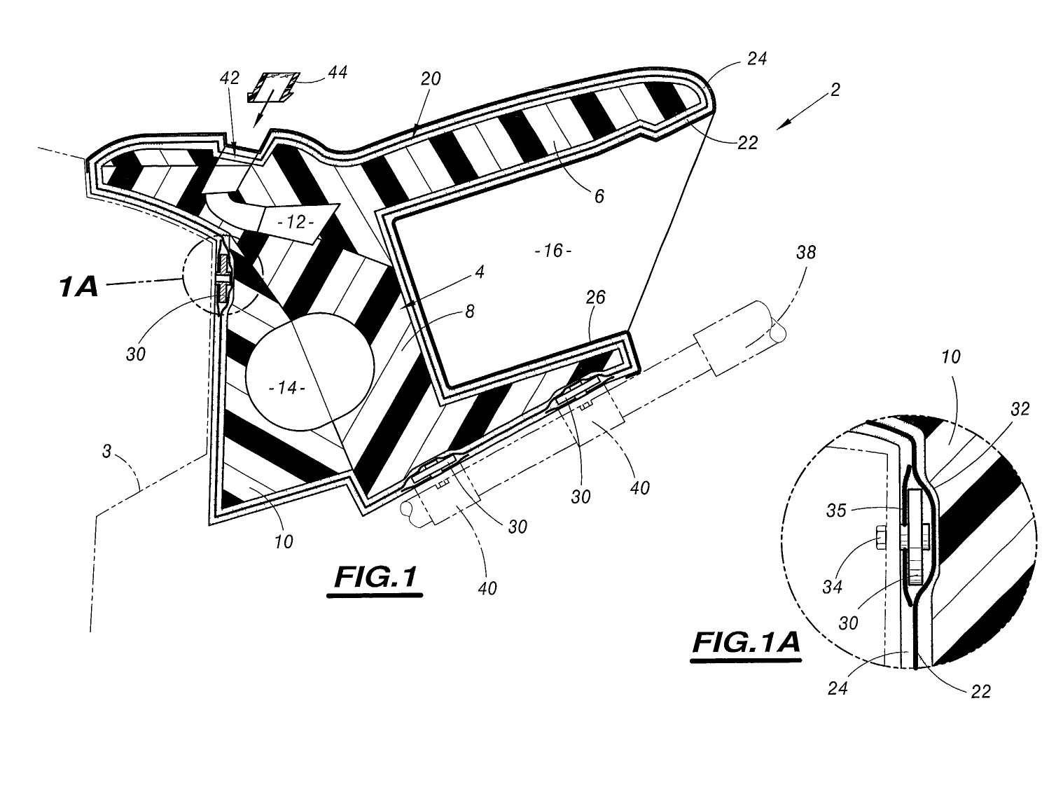

FIG. 1 is a cross-sectional view of a dashboard according to the invention at the driver's location;

FIG. 1A shows, on a larger scale, the detail 1A in FIG. 1;

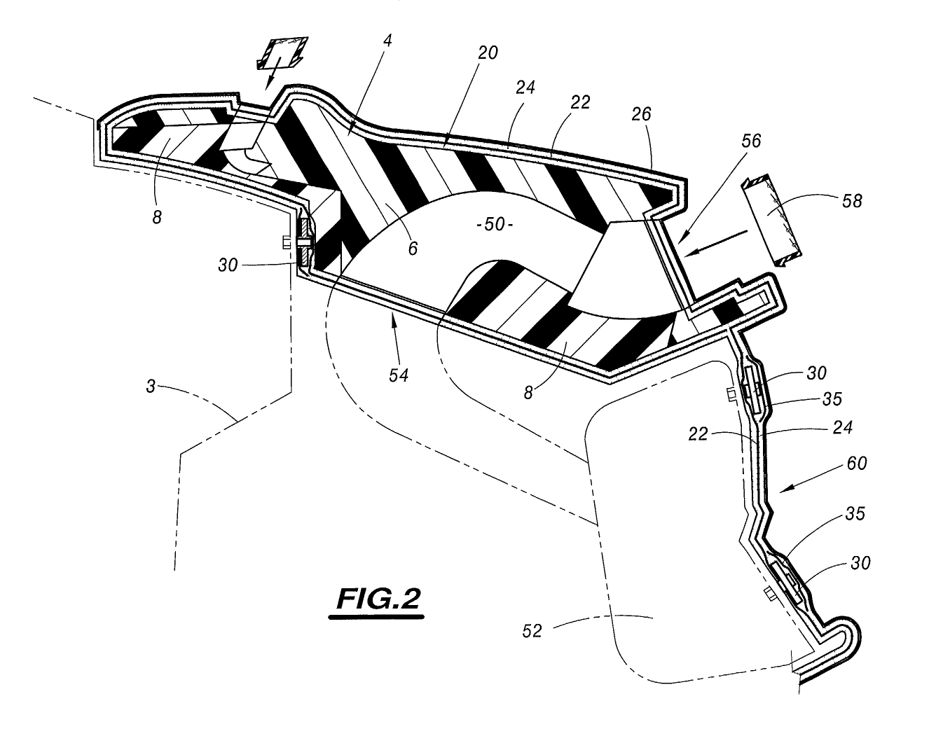

FIG. 2 is a cross-sectional view of the dashboard in FIG. 1 in the central region between the driver region and the passenger region;

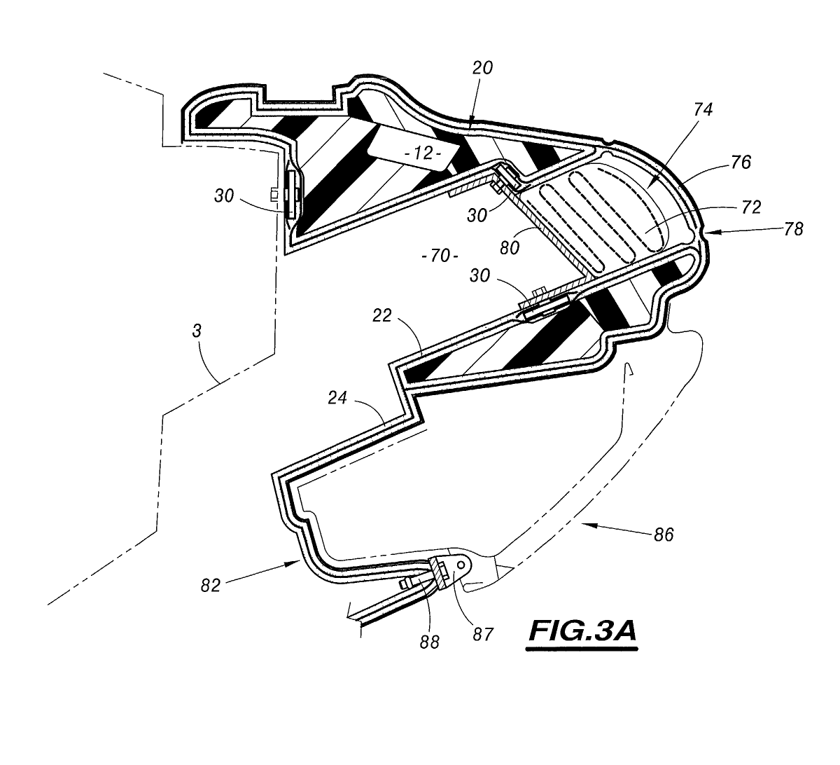

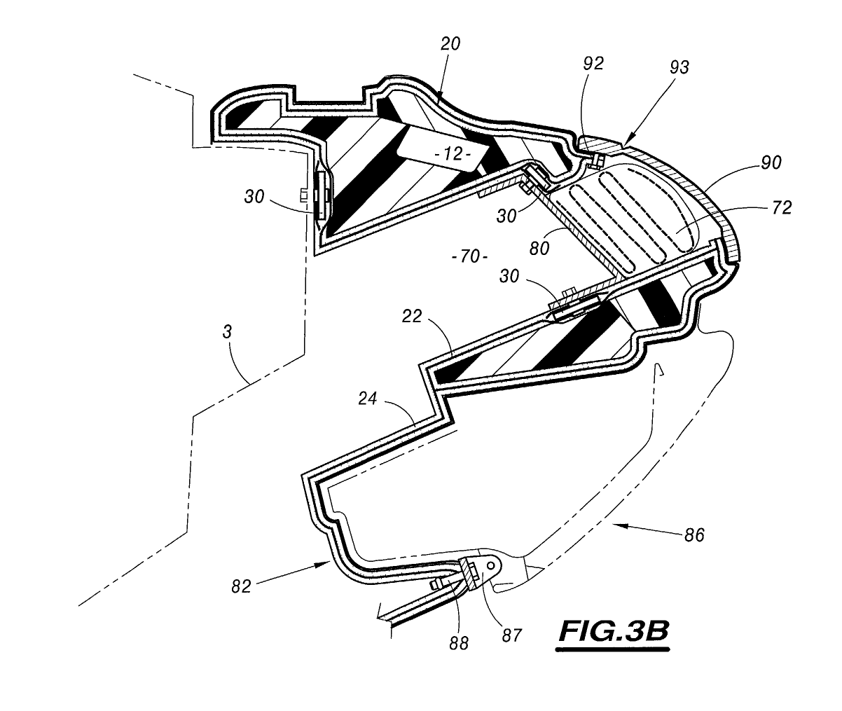

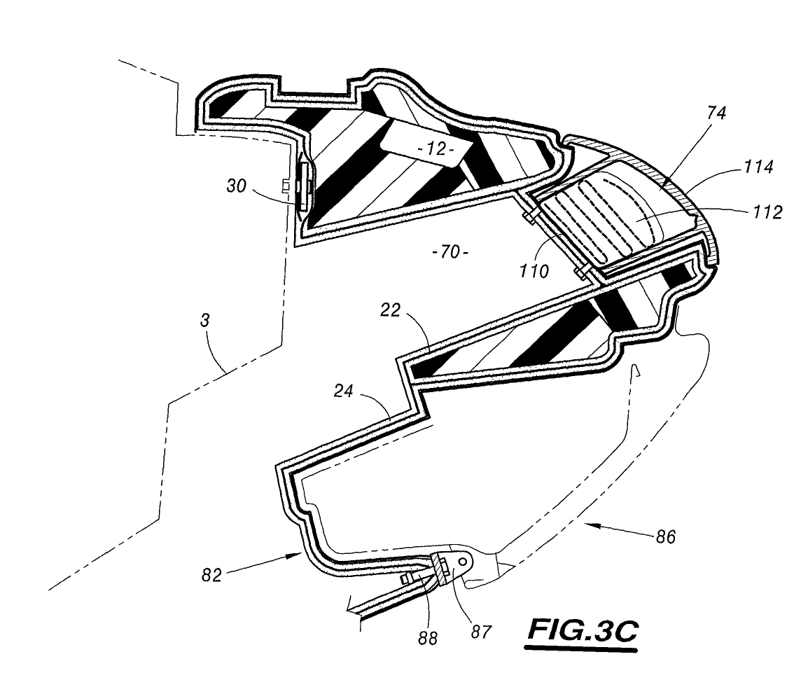

FIG. 3A is a cross-sectional view of the dashboard in FIG. 1 in the passenger region; and

FIGS. 3B and 3C are views corresponding to FIG. 3A of alternative embodiments of a dashboard according to the invention.

The dashboard 2 shown in the drawings is intended to be fitted into a motor vehicle shown schematically by a vehicle front bulkhead 3.

The expressions “front” and “rear” will be used hereafter with respect to the vehicle.

The dashboard 2 comprises a core 4 of plastic foam, which consists of several partial cores 6, 8, 10. The partial cores 6, 8, 10 are joined together by mechanical means or by adhesive bonding. They include recesses which form, in the assembled state, air ducts 12, 14 and a housing 16 for instruments.

The dashboard 2 furthermore includes a stiffening covering 20 comprising a fibre mat 22 incorporated into a layer made of a thermosetting resin 24. This stiffening covering 20 covers approximately the entire surface area of the core 4 so as to guarantee sufficient stiffness. In particular, the cross sections devoid of openings are covered over the entire perimeter. The stiffening covering 20 advantageously has a thickness of between 2 mm and 6 mm, so as to guarantee sufficient stiffness. The fibre mat 22 may, for example, be a glass fibre or felt mat, or a mat of any other suitable material.

The visible portion of the dashboard 2 is covered with a decorative skin 26 known per se, for example made of leather, plastic or fabric. This decorative skin 26 adhesively bonds to the dashboard 2 via the thermosetting resin 24 during casting or injection.

As a variant, this skin may also be adhesively bonded after fitting to the dashboard 2.

In order to make it possible to mount the dashboard 2 into the vehicle or to mount the components into the dashboard, fastening inserts 30 are fastened to the dashboard 2 (see FIG. 1A). For this purpose, the core 4 includes hollowed portions 32 which house the fastening inserts 30.

The inserts are, for example, metal discs having a central tapped hole 34. The fastening inserts 30 are, with the exception of the opening of the tapped hole 34, surrounded by thermosetting resin. In order to guarantee that the fastening inserts 30 are properly bonded to the thermosetting resin 24, they are covered with fibre mat pieces 35 which project from the edges of the inserts 30.

Fastening inserts 30 are designed to fasten the dashboard 2 to the vehicle's front bulkhead 3 which is indicated schematically in FIG. 1.

Two other inserts 30 are provided on the lower portion of the dashboard 2. A steering column 38 is screwed onto these inserts, for example via fastening brackets 40 or via other mechanical means.

Expanded inserts may be added in holes formed by drilling the resin skin in order to fasten various accessories (see the expanded insert 88 described below).

The dashboard 2 furthermore includes an outlet 42 for the air duct 12. This outlet houses a deicing nozzle 44 known per se, and fastened, for example, by snap-fastening.

The outlet 42 is closed by a small section made as one piece with the partial core 6 before the covering with the thermosetting resin, so as to prevent the duct 12 from being blocked. After fitting, the outlet 42 is cut out in the decorative skin 26, the covering 20 and the small section of the partial core 6.

FIG. 2 shows a cross section of the central portion of the dashboard 2.

It may be seen that the dashboard 2 has, in its core 4, a central air duct 50 provided with an inlet 54 which is connected, in the fitted state, to an air-conditioning or heating device 52. This duct 50 also has, on its outlet 56, a space for a fan 58. The description of the outlet 42 applies similarly to the inlet 54 and the outlet 56.

It may also be seen, in the lower and rear portion of the dashboard 2, that a free wall 60 extends towards the bottom. This free wall 60 is formed as one piece with the covering 20 and consists of an extension of the fibre mat 22 covering the core of the dashboard 2, the said core also being embedded in thermosetting resin 24. This wall also preferably has a thickness of between 2 mm and 6 mm.

Fastening inserts 30 are incorporated into the thermosetting resin 24 of the free wall 60 and are thus fastened to the latter. These inserts 30 serve for fastening the air-conditioning unit or the heater 52 at the place formed by the wall 60 of the lower portion of the dashboard or other accessories.

It will be noted that, on the free walls, the fibre mat 22 advantageously covers the fastening inserts 30 on that side where these inserts are stressed by forces, that is to say on the front side in FIG. 2. The other side of the fastening inserts 30 of the free wall 60 is also covered with a fibre mat piece 35.

The rear face of the free wall 60 is covered with the decorative skin 26.

FIG. 3 shows the cross section of the passenger portion of the dashboard 2.

The core 4 of the dashboard 2 has, at this point, a recess 70 which passes through its entire cross section and which forms a housing for an airbag module 72 known per se. The perimeter of this recess 70 is also completely covered with the stiffening covering 20. The rear opening 74 of the recess 70 is covered by a wall 76 formed by fibre mat 22 and thermosetting resin 24. It should be noted that this wall 76 is manufactured as one piece with the rest of the stiffening covering 20. However, the fibre mat 22 is interrupted over at least one portion of the perimeter 78 of the rear opening 74 and the thickness of the wall 76 is reduced around this perimeter, so as to form a line of rupture intended for the airbag.

The airbag module 72 is fastened facing this wall 76 by a fastening bracket 80 which cooperates with fastening inserts 30 incorporated into the covering 20 of the recess 70 in the same way as previously.

As a variant, the fastening bracket 80 may be fastened directly to the covering by screws or by snap-fastening studs.

This section of the dashboard 2 also has a free wall 82 forming a housing 84 for the accommodation of a glove box module 86, indicated schematically. The glove box module 86 is hinged to the free wall via a hinge 87. This hinge 87 is fastened to the wall 82 by an expanded insert 88, known per se, which passes through a drillhole made in this wall.

The dashboard 2 according to the invention is manufactured in the following manner.

Firstly, the partial cores 6, 8, 10 are manufactured from plastic foam, for example expanded polystyrene. They are joined together by mechanical means or by adhesive bonding and the core 4 of the dashboard is thus obtained.

Next, the core 4 is covered with the fibre mat 22 so that the perimeter of the cross section of the core 4 is completely surrounded and so that free portions, intended to form the free walls 60, 82, remain. The recess 70 for accommodating the airbag is also covered with the fibre mat 22.

As a variant, fibre mat preforms may be put into the die and onto the punch of the mould before the core 4 is introduced into the latter.

In the next step, the fibre mat pieces 35 are put over temporary retention elements, for example removable threaded rods provided in a mould. These threaded rods are at the locations of the fastening inserts 30. Next, the fastening inserts are screwed onto the threaded rods.

Next, the covered core 4 is placed in the mould in which the decorative skin has been installed beforehand, in the bottom of the mould. The free portions of the fibre mat 22 are laid freely in corresponding positions in the mould.

As a variant, they may be held in the desired position with respect to the core 4 by peripheral retention means.

Next, after the mould has been closed, thermosetting resin is injected into the mould so that the fibre mat 22 is completely encapsulated in the latter and so that the decorative skin 26 is adhesively bonded to the dashboard 2.

After the resin 24 has cured, the threaded rods are unscrewed from the inserts 30 and the dashboard 2 is demoulded.

Finally, the dashboard 2 is finished by cutting out the openings 42, 54, 56 for the air ducts, by installing the air nozzles 44, 58 and by installing the components, such as the heater/air-conditioning unit 52.

As a variant, thermosetting resin may be injected onto the surface of the decorative skin so as to help to distribute the resin in regions of the dashboard which are covered by this decorative skin.

As a variant, it is also possible to inject thermosetting resin onto the surface of the decorative skin, the core 4 covered with fibre mat is then placed in the mould, the mould is then closed and thermosetting resin is again injected so that the fibre mat is completely encapsulated in the said resin, in the case of a piece of complex shape.

The fact that a large portion of the perimeter of the cross section of the plastic foam core 4 is covered with a hard shell consisting of the thermosetting resin reinforced with the fibre mat makes the dashboard sufficiently stiff.

As a consequence, any metal stiffening bar can be omitted so that the dashboard is a self-supporting dashboard. As a variant, it is, of course, possible to incorporate a metal bar into the dashboard, which bar may then be lightweight.

In addition, given that free walls may be manufactured in a single operation with the covering of the dashboard, the latter has a low manufacturing cost.

By virtue of the fact that the dashboard uses a covering of thermosetting resin, it may be manufactured by low-pressure injection moulding. Consequently, the necessary investment in terms of tooling is low.

FIGS. 3B and 3C show variants of the dashboard according to the invention. The dashboard in FIG. 3B has a recess 70 which passes right through its cross section.

The cover-forming portion 76 of the dashboard according to FIG. 3A is replaced with an attached cover 90. The cover 90 is screwed onto its upper portion on a rim 92 of the covering 20.

The cover 90 has a horizontal groove of weakness 93 in this upper portion, this groove forming a hinge when the airbag is triggered.

The dashboard in FIG. 3C includes a wall 110, made of fibre mat 22 and resin 24, which covers the cross section of the recess 70 approximately in the middle of this recess and which replaces the fastening bracket 80.

An airbag module 112 with integrated cover 114 is fastened in the rear part of the recess 70 by screwing it through this wall 110.

1. Dashboard for a motor vehicle, of the type comprising a core (4) made of plastic foam, consisting of several partial cores (6, 8, 10), including recesses forming air ducts (12) or locations for components (16), and having a covering (20) comprising a fibre mat (22) incorporated into a layer of polymer resin (24), characterized in that the covering is a stiffening covering (20) completely surrounding the perimeter of the cross section of the core (4) over at least part of the length of the latter.

2. Dashboard according to claim 1, characterized in that the polymer resin is a thermosetting resin (24).

3. Dashboard according to claim 1, characterized in that it includes at least one free wall (60, 82; 110) made as one piece with the stiffening covering (20) and consisting of the fibre mat (22) incorporated into a layer of polymer resin (24).

4. Dashboard according to claim 1, characterized in that it furthermore includes at least one element (30) for fastening the dashboard (2) to the vehicle (3) or for fastening components (38, 86) to the dashboard (2) and in that the fastening element is moulded in the polymer resin (24).

5. Dashboard according to claim 1, characterized in that the fastening element (30) is surrounded, on one side, by the fibre mat (22) and, on the other side, by a fibre mat piece (35) which projects beyond the edges of the fastening element (30).

6. Dashboard according to claim 1, characterized in that the fastening element (30) is surrounded by the fibre mat (22) on that side stressed by a force in the fitted state.

7. Dashboard according to claim 1, characterized in that a decorative skin (26), especially made of leather or plastic, is fastened to the visible parts of the dashboard (2), in the fitted state, by the polymer resin (24).

8. Dashboard according to claim 1, characterized in that it includes a recess (70) made in the core (4) for an airbag module (72; 112).

9. Dashboard according to claim 1, characterized in that it includes a free wall (110) which covers the cross section of the recess (70), at a location substantially away from the rear opening of this recess, this free wall (110) being intended for fastening the airbag module.

10. Dashboard according to claim 1, characterized in that the recess (70) passes through the core (4).

11. Dashboard according to claim 1, characterized in that it is covered over its rear opening by a portion (76) of the stiffening covering (20) and in that the stiffening covering has a region of weakness (78) intended for rupturing when the airbag is triggered, this region of weakness (78) being formed by a weakened cross section of the stiffening covering (20) and containing no fibre mat (22).

12. Dashboard according to claim 1, characterized in that the layer of polymer resin has a thickness of between 2 mm and 6 mm.

13. Dashboard according to claim 1, characterized in that it is a self-supporting dashboard (2).

14. Dashboard module comprising a dashboard according to claim 1 and at least one item of equipment (52) fastened to it.

15. Dashboard module according to claim 14, characterized in that it furthermore includes an airbag module (112) fitted into the recess (70), this airbag module having an integrated cover (114).

16. Dashboard module according to claim 14, characterized in that it furthermore includes an airbag module (72) and an attached cover (90) which covers the rear opening of the recess (70) and which is fastened to the perimeter of this recess (70).

17. Process for manufacturing a dashboard according to claim 1, comprising the following steps:
partial cores (6, 8, 10) of plastic foam are assembled into a core (4);
the core (4) is covered with a fibre mat (22) so that the perimeter of the cross section of the core (4) is completely surrounded by the fibre mat (22);
the covered core (4) is placed in a mould;
polymer resin is injected into the mould so that the fibre mat (22) is completely incorporated into a layer of polymer resin;
the polymer resin is left to cure and the dashboard is demoulded; and
openings for air ducts and/or locations for components are cut out.

18. Process for manufacturing a dashboard according to claim 1, comprising the following steps:
partial cores (6, 8, 10) of plastic foam are assembled into a core (4);
preformed pieces of fibre mat of a shape substantially complementary to that of the core (4) are placed in the die and/or the punch of a mould, the preformed pieces having a total surface area completely covering the core (4);
the core (4) is placed in the mould;
polymer resin is injected into the mould so that the fibre mat is completely incorporated into a layer of polymer resin;
the polymer resin is left to cure and the dashboard is demoulded; and
openings for air ducts and/or locations for components are cut out.

19. Manufacturing process according to claim 17 or 18 for manufacturing a dashboard (2) according to claim 4 or one of the claims dependent on claim 4, characterized in that it furthermore includes the step, before the polymer resin is injected, of placing fastening elements (30) on temporary retention elements arranged in the mould.

20. Manufacturing process according to claim 19, characterized in that it furthermore includes the step of placing fibre mat pieces (35) on the temporary retention elements arranged in the mould before the fastening elements (30) are put into place.

21. Manufacturing process according to claim 17, characterized in that it furthermore includes the steps of placing a decorative skin (26) in the mould and of injecting polymer resin onto the face of the decorative skin (26) being applied against the dashboard.
